(19) United States
(12) Patent Application Publication
(10) Pub. No.: US 2025/0346199 A1
(43) Pub. Date: Nov. 13, 2025

(54) Profile-Based Customization of Shared Spaces

(71) Applicants: AT&T Intellectual Property I, L.P., Atlanta, GA (US); AT&T Mobility II LLC, Atlanta, GA (US)

(72) Inventors: Rashmi Palamadai, Naperville, IL (US); Peter Wong, Redmond, WA (US); Robert Holden, Allen, TX (US)

(73) Assignees: AT&T Intellectual Property I, L.P., Atlanta, GA (US); AT&T Mobility II LLC, Atlanta, GA (US)

(21) Appl. No.: 18/660,772

(22) Filed: May 10, 2024

(51) Int. Cl. B60R 16/037; H04L 67/306

(52) U.S. Cl. CPC B60R 16/037; H04L 67/306

(57) ABSTRACT

Concepts and technologies disclosed herein are directed to applying a user profile to a shared space to customize at least one characteristic of the shared space. The shared space can obtain identification information corresponding to a user associated with the shared space and can determine, based at least on the identification information, if the user is a primary user of the shared space. If the shared space determines that the user is not the primary user of the shared space, the shared space can receive a user profile associated with the user from a customization service system. The shared space can instruct a control unit of the shared space to apply the user profile to the shared space to customize the shared space based on the user profile.

### BACKGROUND

In today's interconnected world, shared spaces like connected cars have become integral components of our daily lives, facilitating collaborative experiences and enhancing convenience for multiple users. Customization of these shared environments is paramount to address the diverse needs and preferences of individual users within the same space. Personalization allows occupants to tailor their surroundings to match their specific comfort, safety, and entertainment requirements, thereby optimizing the overall user experience. In a connected car scenario, where passengers may vary in age, mobility, technological familiarity, and personal preferences, the ability to customize features such as seating arrangements, climate control settings, infotainment options, and safety configurations becomes essential and allows for a seamless transition as users move from personal spaces to shared spaces. Moreover, extending customization to emergency personnel in order to transform a shared space into an emergency response unit allows faster response time during natural disasters and emergencies.

### SUMMARY

Concepts and technologies disclosed herein are directed to applying a user profile to a shared space to customize at least one characteristic of the shared space based on the user profile. According to one aspect disclosed herein, the shared space can include a processor and a memory. The memory can store instructions and a customization client that, when executed by the processor, cause the processor to perform operations. In particular, the shared space can obtain identification information corresponding to a user associated with the shared space. The shared space can determine, based at least in part on the identification information, if the user is a primary user of the shared space. If the shared space determines that the user is the primary user of the shared space, the shared space can provide a primary user profile associated with the primary user to the control unit of the shared space to customize the shared space based on the primary user profile. If, on the other hand, the shared space determines that the user is not the primary user of the shared space, the shared space can receive a user profile associated with the user from a customization service system. The shared space can instruct a control unit of the shared space to apply the user profile to the shared space to customize the shared space based on the user profile. According to embodiments, applying the user profile to the shared space comprises adjusting at least one component of the shared space based on the user profile.

According to embodiments, the shared space can compare the user profile to the primary user profile to determine if the user profile exceeds the primary user profile. If a determination is made that the user profile does not exceed the primary user profile, the shared space can instruct the control unit of the shared space to apply the user profile to the shared space to customize the shared space based on the user profile. If, on the other hand, a determination is made that the user profile does exceed the primary user profile, the shared space can determine whether the user is a member of a user exception group. If the user is determined to be a member of the user exception group, the shared space can instruct the control unit of the shared space to apply the user profile to the shared space to customize the shared space based on the user profile. If, on the other hand, a determination is made that the user is not a member of the user exception group, the shared space can instruct the control unit of the shared space to apply portions of the user profile that do not exceed the primary user profile to the shared space to customize the shared space.

The shared space can also determine whether the user remains associated with the shared space. If a determination is made that the user is no longer associated with the shared space, the shared space can instruct the controller of the shared space to apply the primary user profile to the shared space to customize the shared space based on the primary user profile.

It should be appreciated that the above-described subject matter may be implemented as a computer-controlled apparatus, a computer process, a computing system, or as an article of manufacture such as a computer-readable storage medium. These and various other features will be apparent from a reading of the following Detailed Description and a review of the associated drawings.

Other systems, methods, and/or computer program products according to embodiments will be or become apparent to one with skill in the art upon review of the following drawings and detailed description. It is intended that all such additional systems, methods, and/or computer program products be included within this description, be within the scope of this disclosure.

### BRIEF DESCRIPTION OF THE DRAWINGS

FIG. 1 is a block diagram illustrating aspects of an illustrative operating environment for various concepts and technologies disclosed herein.

FIGS. 2A-2B are flow diagrams illustrating aspects of a method for customizing a shared space based on a user profile, according to an illustrative embodiment of the concepts and technologies disclosed herein.

FIG. 3 is a flow diagram illustrating aspects of a method for generating and managing user profiles for customizing a shared space, according to an illustrative embodiment of the concepts and technologies disclosed herein.

FIG. 4 is a block diagram of an example network, according to an illustrative embodiment.

FIG. 5 is a block diagram illustrating a computer system configured to provide the functionality in accordance with various embodiments of the concepts and technologies disclosed herein.

FIG. 6 is a block diagram of a mobile device and components thereof, according to an illustrative embodiment.

FIG. 7 is a block diagram illustrating a cloud computing platform capable of implementing aspects of the concepts and technologies disclosed herein.

FIG. 8 is a diagram illustrating a machine learning system capable of implementing aspects of the embodiments disclosed herein, according to an illustrative embodiment.

### DETAILED DESCRIPTION

The concepts and technologies disclosed herein provide a customization service system that collects, aggregates, and manages user data from multiple sources to create and maintain user profiles that can be applied to a shared space for customization of at least one characteristic of the shared space. The shared space can be a vehicle, equipment, building, room, or any other place that has and/or is shared by multiple users. Example characteristics that can be modified by a user profile can include one or more climate settings, equipment configurations, infotainment system settings, navigation preferences, driving mode and assistance preferences, lighting and display settings, safety settings, and/or connectivity settings of a shared space. The shared space can include a customization client that receives a user profile from the customization service system and determines which preferences and parameters of the user profile to apply to one or more characteristics of the shared space. According to embodiments, the customization client determines which portions of the user profile to apply to the shared space based on determining a categorization of the user in relation to the shared space. For instance, the customization client can determine whether the user is a primary user of the shared space, secondary user of the shared space, and/or a member of a user exception group. The customization client can instruct one or more controllers of the shared space to apply at least a portion of the user profile to adjust and customize one or more components of the shared space for the user.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

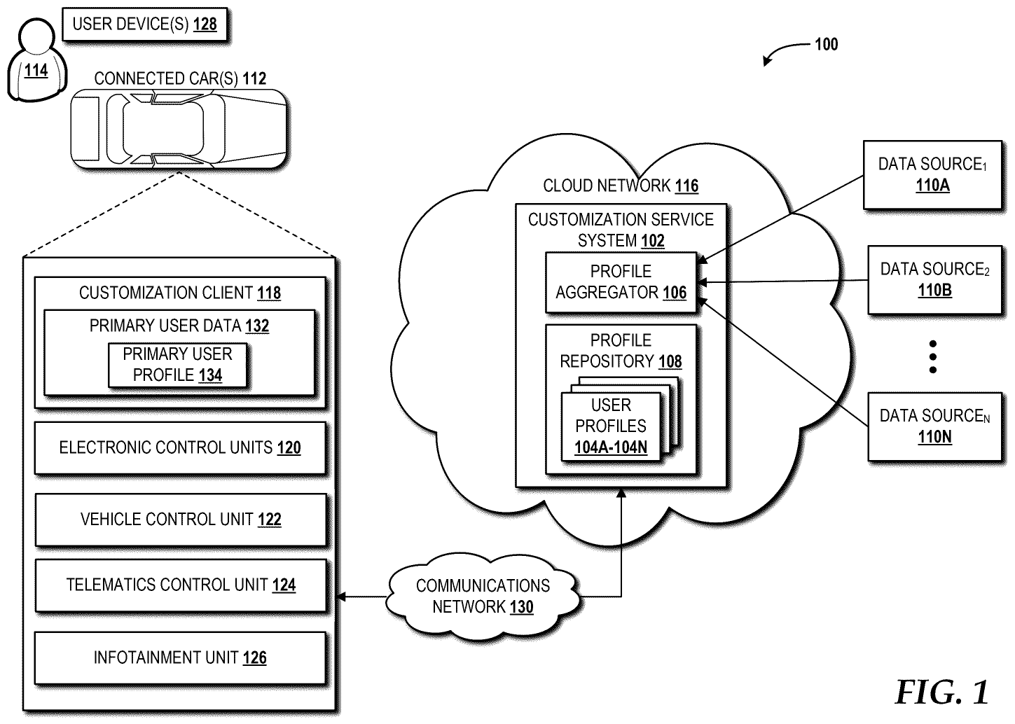

Turning now to FIG. 1, aspects of an operating environment 100 for various embodiments of the concepts and technologies disclosed herein will be described, according to an illustrative embodiment. The operating environment 100 includes a customization service system 102 that provides a shared space customization service capable of collecting a variety of user data associated with one or more users, processing the user data to generate user profiles 104A-104N, and storing the user profiles 104A-104N for access by a shared space, such as a connected car 112. According to embodiments, the customization service system 102 includes a profile aggregator 106 and a profile repository 108. The profile aggregator 106 can collect, aggregate, and manage user data received from multiple data sources 110A-110N to generate and maintain user profiles, such as the user profiles 104A-104N. The user profiles 104A-104N can be stored in the profile repository 108 for access by a shared space, such as the connected car 112, to be applied to customize at least one feature of the shared space for a user determined to be associated with the connected car. According to embodiments, the customization service system 102 can be hosted by computing resources associated with a cloud network 116.

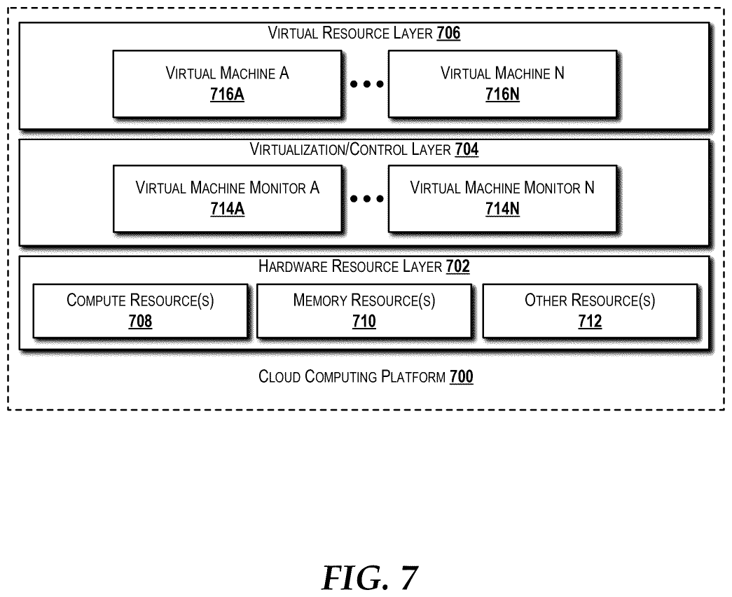

The cloud network 116 can be a private cloud network, a public cloud network, a hybrid cloud network, or a multi-cloud network. Although one cloud network 116 is illustrated, the concepts and technologies disclosed herein can be applied to multiple cloud networks 116 hosting one or more customization service systems 102. As used herein, a “private cloud network” is a cloud network that is provisioned for use by a one or more select customers. As used herein, a “public cloud network” is a cloud network that is provisioned for public use (i.e., anyone who wants to use or purchase access). As used herein, a “hybrid cloud network” can include at least two private clouds, at least two public clouds, or at least one private cloud and at least one public cloud. As used herein, a “multi-cloud network” includes any combination of public and/or private clouds from more than one cloud service provider. The cloud network 116 can provide one or more cloud services such as Infrastructure-as-a-Service (“IaaS”), Platform-as-a-Service (“PaaS”), and/or Software-as-a-Service (“SaaS”) via cloud resources. The cloud resources can be executed on top of host hardware such as compute resources, memory resources, and other hardware resources. Additional details in this regard will be described herein with reference to an example cloud computing platform 700 shown in FIG. 7.

Turning back to the customization service system 102, the profile aggregator 106 can employ a variety of data collection mechanisms including, but not limited to, connectors, APIs, SDKs, and webhooks, to gather user data from the data sources 110A-110B. The data sources 110A-110N can include, but are not limited to, input from users of the shared space customization service provided by the customization service system 102, social media platforms, e-commerce services, streaming services, online forums and communities, mobile applications, customer relationship management systems, IoT devices and sensors, communication service provider network elements, and the like. The profile aggregator 106 can receive user identification information identifying a user, such as the user 114, for which user data should be collected and can use the user identification information to identify user data for collection from the data sources 110A-110N. The user identification information can include the user's name, email address, phone number and/or any other unique identifier of one or more devices associated with the user, username, physical address, biometric information, social security number, and/or any other information that can uniquely identify a user. The profile aggregator 106 may receive user identification information associated with a user when the user registers for the shared space customization service provided by the customization service system 102, through an authentication process associated with the customization service system 102, through interaction with the customization service system 102 by a device associated with the user, and/or any other method of receiving or inferring user identification information associated with a user.

According to embodiments, the profile aggregator 106 of the customization service system 102 can focus on collecting user data associated with identification information that matches at least a portion of the received user identification information of a user, such as the user 114, and that is related to and/or relevant to the operation, usage, and/or maintenance of a shared space in order to generate user profiles, such as the user profiles 104A-104B, that are pertinent to the shared space. For example, the profile aggregator 106 can gather user data from connected car/shared car platforms of vehicle manufacturers and third-party providers that store vehicle settings, driving behavior, and trip history associated with the user 114; smart home platforms that store settings associated with a connected home or business associated with the user 114; and/or third-party service providers that provide any kind of service that tracks preferences and settings associated with the user 114 such as, but not limited to, music apps, parking apps, social media apps, weather apps, gaming apps, fitness and health apps, navigation apps, search engines and browsers, streaming services, and/or e-commerce apps. Additionally, the customization service system 102 can be provided by a telecommunications service provider that stores and has access to a variety of information associated with a user's use of services provided by the telecommunications service provider including, but not limited to, telephone services, mobile device services, internet services, television services, and the like.

The user data collected from the data sources 110A-110N can include user data stored in user profiles by the data sources 110A-110N as well as user data not directly stored in user profiles by the data sources 108A-108N. The user data collected by the profile aggregator 106 can include information associated with a particular user that can be used to adjust settings of one or more shared spaces determined to be associated with the particular user in order to customize the one or more shared spaces for the particular user. This information can include, but should not be limited to, personal preference information including preferred climate control settings, lighting levels, seating arrangement, workspace layout, media playback preferences, radio presets, navigation history, and driver assistance system preferences; communication preference information including preferences for receiving notifications, alerts, and updates as well as preferred communication channels (e.g., email, SMS, in-app notifications) and language preferences; security preference information for accessing and securing the shared space including authentication methods and access control settings; privacy preference information related to data sharing and usage within the shared space including consent for data collection, sharing preferences with others users, and privacy controls for personal information; billing and payment information including billing and payment preferences and methods for managing expenses associated with a shared space; usage history and behavior information including historical data on usage patterns and behavior within shared spaces including trip durations, distances traveled, average speed, fuel consumption, and driving style; networking preference information within a shared space, and/or any other information for customizing a shared space. According to embodiments, the profile aggregator 106 can use the collected user data as training data for a generative artificial intelligence (“AI”) model, such as generative adversarial networks, variational autoencoders, autoregressive models, transformer models, and/or flow-based models to create new user data associated with a particular user.

The user data collected and/or generated by the profile aggregator 106 can be filtered and processed to generate one or more user profiles, such as the user profiles 104A-104N, for each of a plurality of users. According to embodiments, the profile aggregator 106 can process the user data gathered from the data sources 110A-110N to standardize formats, resolve inconsistencies, and reconcile disparate identities associated with the same user across different ones of the data sources 110A-110N. The profile aggregator 106 can group the user data based on the user data's association with a particular user and relevance to a particular shared space in order to generate the user profiles 104A-104N. One or more of the user profiles 104A-104N generated by the profile aggregator 106 associated with a particular user can include information tailored to manage settings of one or more shared spaces so as to customize the shared space for the particular user. Accordingly, a user, such as the user 114, can be associated with a specific user profile for each of a plurality of shared spaces. For example, the user 114 can be associated with a first user profile related to a connected car, such as the connected car 112, for which the user 114 is considered the primary user as well as a second user profile related to a different connected car, such as a rental car, for which the user 114 is considered a secondary user, as discussed further below. Additionally, the user 114 can be associated with a third user profile associated with a shared office space.

The profile aggregator 106 may manage the user profiles 104A-104N such that existing user profiles may be deleted (e.g., users manually delete corresponding user profiles, users fail to renew subscriptions, etc.) and/or new user profiles may be set up (e.g., new users subscribe to a service such as a car rental service and/or existing users open another account). For example, the profile aggregator 106 may host a website, an application, or otherwise provide an interface to allow new users to set up an account and/or existing users to adjust/delete information associated with a corresponding user profile. Additionally, the profile aggregator 106 can dynamically update one or more of the user profiles 104A-104N by continuously collecting, processing, and integrating new data from the data sources 110A-110N. In some cases, the profile aggregator 106 may perform authentication processes and/or provide data (e.g., transmit data or otherwise allow access to data) to facilitate performing of authentication processes.

The profile repository 108 of the customization service system 102 serves as a centralized storage and management system for storing, organizing, and providing access to the user profiles 104A-104N generated by the profile aggregator 106. According to embodiments, the profile repository 108 utilizes a database or data warehouse to store the user profiles 104A-104N. The user profiles 104A-104N can be associated with unique identifiers, such as user IDs, customer IDs, or device IDs, for indexing and accessing the user profiles 104A-104N within the profile repository 108. Each unique identifier can be correlated with user identification information identifying a particular user associated with each of the user profiles 104A-104N. As discussed further below, identification information corresponding to a user determined to be associated with a shared space can be provided to the customization service system 102 by the shared space. The customization service system 102 can determine a unique ID associated with user identification information that matches the identification information received from the shared space and can use the unique ID to determine which user profile(s) to provide to the shared space for customizing at least one feature of the shared space.

FIG. 1 further illustrates an example of a shared space represented by a connected car 112, in accordance with an illustrative embodiment. Not all of the depicted components may be required, however, and one or more embodiments may include additional components not shown in the figure. Variations in the arrangement and type of the components may be made without departing from the spirit or scope of the claims as set forth herein. Additional components, different components, and/or fewer components may be provided. Although the shared space is shown and described as being a connected car 112, it should be understood that the shared space could be other types of vehicles, equipment, a building, a room, or any other place that is shared and/or swapped by multiple users.

According to embodiments, the connected car 112 includes a customization client 118, electronic control units (“ECUs”) 120, a vehicle control unit (“VCU”) 122, a telematics control unit (“TCU”) 124, and an infotainment unit 126. The components of the connected car 112 can be connected to and communicate via a data bus (not shown). The data bus of the connected car 112 may provide pathways for multiple network protocol communications such as, but not limited to controller area network (“CAN”), local interconnect network (“LIN”), FlexRay, media-oriented system transport (“MOST”), and the like. In some cases, the ECUs 120, VCU 122, TCU 124, infotainment unit 126, and data bus may collectively provide a hardware platform of the connected car 112.

The ECUs 120 of FIG. 1 may be discrete computing devices, each including a processor (e.g., a microcontroller) to process data and execute programmable instructions (e.g., assembly level instructions, functional sequential instructions, and/or object-oriented instructions). Each of the ECUs 120 may include on-board memory (e.g., static random-access memory (“SRAM”), electrically erasable programmable read-only memory (“EEPROM”), and/or flash memory) to store data received and/or generated by the ECUs 120. The ECUs 120 may include input and/or output (“I/O”) ports such as supply voltage inputs, digital and/or analog inputs, relay drivers, H-bridge drivers, injector drivers, and/or logic outputs. These I/O ports may be used by the ECUs 120 to receive data (e.g., instructions, sensor data) and transmit signals to components (e.g., actuators, switches) to affect the components' operations based on characteristics (e.g., behaviors, locations, and/or orientations) to be effectuated through application of one or more of the user profiles 104A-104N from the customization service system 102. The received data and/or the transmitted signals may be communicated from the ECUs 120 via the data bus or through a directly wired connection between the ECUs 120 and the components.

In some aspects, systems (e.g., cabin, engine, cooling, suspension, etc.) of the connected car 118 may operate within confines of operating parameters configured into the systems' corresponding ECUs 120. By way of non-limiting examples, the ECUs 205 may control cabin characteristics, engine performance, transmission, suspension brakes, tire inflation, and/or other aspects of the connected car 112. Each of the ECUs 120 may control an individual aspect of the connected car 112. The ECUs 120 may accept programmed instructions, such as instructions based on one or more of the user profiles 104A-104N, that alter the control of a corresponding system of the connected car 112, as discussed further below.

Each of the ECUs 120 may monitor its corresponding system by reading sensor signals. These sensors may be placed on the mechanical components of the corresponding system and report factors such as a behavior (e.g., temperature for a heating system, cushion hardness for a seat, etc.), a location, and/or an orientation. These factors contribute to if, when, and/or how the ECUs 120 generates output signals to effectuate control over the corresponding system. As an example, a seat ECU may have sensors monitoring a location and an orientation of a seat in the cabin of the connected car 112. In response to an indication to adjust the location and orientation of the seat, the seat ECU may send control signals to actuators to move and rotate the seat as appropriate according to the indication and verify, using the sensors, that the move and rotation of the seat are properly performed. The indication to adjust may be due to receipt by the connected car 112 of one of the user profiles 104A-104N.

The infotainment unit 126 of the connected car 112 includes components such as a dashboard display, a media center, a center console display, and driver accessible buttons (e.g., temperature controls, door lock controls). The infotainment unit 126 may also include a data store to store media (e.g., movies, music, television programs, podcasts, etc.); system firmware; navigation data; diagnostic information; settings information gathered by the infotainment unit 126 including radio settings, climate control settings, navigation settings, vehicle settings, phone and connectivity settings, display and user interface settings, maintenance and diagnostic settings, and/or safety and assistance settings; data collected by data collection systems (e.g., cameras mounted externally on the connected car 112, weather data collection, etc.), and/or one of more of the user profiles 104A-104N.

The infotainment unit 126 may also function as a user interface that provides options to a user of the connected car 112 and communicates the user's selected options to the corresponding ECU 120 and/or the VCU 122. In some cases, the infotainment unit 126 may present selection options associated with one or more of the user profiles 104A-104N to a user via a center console display and communicate selected options to the VCU 122. In an embodiment, a user device 128 may be utilized in place of or in addition to the infotainment unit 126, at least with regard to presenting selection options associated with one or more of the user profiles 104A-104N.

The TCU 124 may include one or more radio transceivers (e.g., antennas) along with associated logic, circuitry, interfaces, memory, and/or code that enable communications via wireless interfaces with devices, such as the user device 128. In addition, the TCU 124 can communicate wirelessly with sensors and interfaces onboard the connected car 112 to collect data about the performance, status, and environment of the connected car 112. In an embodiment, the TCU 124 may send and/or receive information via communications in accordance with wireless communication standards or protocols, such as a cellular standard, Institute of Electrical and Electronics Engineers (IEEE) 802.11 standard, BLUETOOTH standard, ZIGBEE standard, and/or other wireless standards; NFC; infrared-based communications; optical-based communications; and/or other appropriate communication standards and/or protocols. In some cases, the TCU 124 may be configured to communicate with devices using a proprietary wireless communication protocol and interface. Alternatively or in addition, the TCU 124 may include suitable logic, circuitry, interfaces, memory, and/or code that enable wired communications. In this regard, the connected car 112 may be configured to interface with a wired network, such as via an Ethernet interface, a power-line modem, a Digital Subscriber Line (DSL) modem, a Public Switched Telephone Network (PSTN) modem, a cable modem, and/or other appropriate components for wired communication. A wired link may be implemented with a USB cable, power-line cable, coaxial cable, fiber-optic cable, or other cable or wires that support corresponding wired network technologies. For instance, the TCU 124 may be, or may include, a USB port that can receive a USB cable. When the USB cable is used to connect, for example, the user device 128 to the connected car 112, the USB cable may be used to transmit data to and/or receive data from the user device 128. In addition, the TCU 124 can communicate with sensors and interfaces onboard the connected car 112 through wired connections using communication protocols such as CAN, LIN, FlexRay, and the like to collect data about the performance, status, and environment of the connected car 112.

In some embodiments, the TCU 124 may communicate directly with the user device 128 (e.g., directly with a communication unit of the user device 128 in a non-networked manner), such as via BLUETOOTH communication and/or NFC communication. For instance, the TCU 124 may be, or may include, an NFC device (e.g., NFC tag) that may transmit data to and/or receive data from the user device 128 when the user device 128 is placed in proximity of the NFC device. The TCU 124 may also include components that facilitate reception from terrestrial radio networks, digital satellite radio networks, internet-based radio service networks, combinations thereof, and the like. For instance, the TCU 124 can include a GPS receiver to determine a location of the connected car 112, which can be used for navigation, tracking, and location-based services.

The connected car 112 may be in communication with other components, such as the customization service system 102, via a communications network 130. As one example, the communications network 130 may be, may include, or may be a part of, a cellular network. In this example, the TCU 124 of the connected car 112 may include a communication module that sends and/or receive information over the cellular network (e.g., 3G, 4G, 5G, 6G, and greater generation technology standards, other 3GPP-based cellular network, and/or other cellular network), such as to and/or from the customization service system 102 and/or the user device 128, via one or more base stations (not shown) of the communications network 130. The base station(s) may be macrocell base station(s), microcell base station(s), picocell base station(s), femtocell base station(s), and/or other cell sizes. Although the communications network 130 is depicted as a single network, the communications network 130 may include one or more networks. In this regard, the communications network 130 may represent one or more wireless networks (e.g., cellular network, WI-FI network) and/or one or more wired networks.

The VCU 122 of the connected car 112 manages and coordinates various systems and subsystems within the connected car 112. According to embodiments, the VCU 122 processes sensor data, executes control algorithms, and coordinates operation of components of the connected car 112. The VCU 122 is in communication with components of the connected car 112 including the ECUs 120, the TCU 124, and the infotainment unit 126. According to embodiments, the VCU 122 can act as a controller for components of the connected car 112, such as the ECUs 120, and can instruct the components to adjust a behavior, location, and/or orientation based on commands received by the VCU 122.

In some cases, the VCU 122 may receive one or more user profiles, such as one or more of the user profiles 104A-104N, from the customization service system 102 via a customization client 118 executing on the connected car 112. As discussed further below, the customization client 118 works in conjunction with the customization service system 102 to identify a user profile corresponding to a user of the connected car 112 and provide the user profile to the VCU 122 to adjust at least one component of the connected car 112 based on information of the user profile. The customization client 118 can be a software module executed, for example, by one or more computing systems operating as part of the connected car 112. According to embodiments, the customization client 118 could be executed by the VCU 122, the TCU 124, the infotainment unit 126, or some other computing component of the connected car 112. Alternatively, the customization client 118 can be hardware modules or combinations of hardware and software that perform the operations described herein.

The customization client 118 can store primary user data 132 associated with the primary user of a shared space, such as the connected car 112. Although only one primary user is discussed, a shared space could be associated with more than one primary user. The primary user may be a person, business, or other entity that predominantly operates, maintains, and/or has legal ownership or primary responsibility for the shared space. As an example, for the connected car 112 owned by a family, one or more adults eighteen years or older who is/are the main driver(s) of the connected car 112 and/or the person(s) responsible for insurance, registration, and/or other administrative tasks related to the connected car may be considered the primary user(s). Minors of the family under the age of eighteen may be considered secondary users of the connected car 112. For the connected car 112 owned by a car rental business, one or more individuals who work for the car rental business may be considered the primary user(s) of the connected car 112, while any renter would be designated a secondary user. The primary user data 132 includes information identifying the primary user of the connected car 112 such as, but not limited to, name, username, email address, phone number, user authentication information, unique identifiers associated with one or more user devices of the primary user, biometric information, government-issued identifiers, payment information, and/or any other information that is distinct to a user.

The primary user data 132 may also include a primary user profile 134. The primary user profile 134 is associated with the primary user of a shared space, such as the connected car 112, and includes information that can be used to manage settings of one or more components of the shared space as customized and/or preferred by the primary user. This information can include personal preference information such as preferred climate control settings, lighting levels, seating arrangement, workspace layout, media playback preferences, radio presets, navigation history, and driver assistance system preferences; communication preference information including preferences for receiving notifications, alerts, and updates as well as preferred communication channels (e.g., email, SMS, in-app notifications) and language preferences; security preference information for accessing and securing the shared space including authentication methods and access control settings; privacy preference information related to data sharing and usage within the shared space including consent for data collection, sharing preferences with others users, and privacy controls for personal information; billing and payment information including billing and payment preferences and methods for managing expenses associated with a shared space; usage history and behavior information including historical data on usage patterns and behavior within shared spaces including trip durations, distances traveled, average speed, fuel consumption, and driving style; networking preference information within a shared space, and/or any other information for customizing a shared space. According to embodiments, the components of the connected car 112 are set based on the information of the primary user profile 134 as a default. The primary user profile 134 can be generated by the customization client 118 based on settings information received from one or more of the primary user, the ECUs 120, the VCU 122, the TCU 124, the infotainment unit 126, and/or combinations thereof. Additionally, or alternatively, the primary user profile 134 can be generated by the profile aggregator 106 in the manner discussed above and provided to the customization client 118 via the communications network 130.

Prior to providing a user profile to the VCU 122, the customization client 118 can identify a user, such as the user 114, determined to be associated with the connected car 112. The user 114 may be determined to be associated with the connected car 112 in response to the connected car 112 detecting the presence of the user device 128 in proximity to the connected car 112 via, for example, BLUETOOTH or NFC communication. The user 114 may also be determined to be associated with the connected car 112 in response to the user 114 registering to use/rent the connected car 112, in response to the user 114 providing input to the connected car 112 either via a user interface provided by the connected car 112 or the user device 128, in response to one or more sensors of the connected car 112 capturing biometric data associated with the user 114, and/or any other method of determining an association between the user 114 and the connected car 112. The customization client 118 can identify the user 114 based on obtaining identification information associated with the user 114. For example, the customization client 118 can provide a user interface on a display associated with the infotainment unit 126 or another compatible display of the connected car 112 prompting the user 114 to input identification information to register with the customization client 118. Alternatively, in response to the user device 128 being detected within proximity of the connected car 112, the customization client 118 can provide a user interface to the user device 128 to prompt the user 114 for identification information. Moreover, the connected car 112 may pair with one or more wearable devices (not shown) associated with the user 114 to extract identification information corresponding to the user 114 that is provided to the customization client 118.

Regardless of how the identification information of the user 114 is obtained by the customization client 118, the customization client 118 can use the identification information to determine whether the user 114 is a primary user of the connected car 112. For instance, the customization client 118 can compare the identification information corresponding to the user 114 with the information identifying the primary user from the primary user data 132. If a determination is made, based on the comparison, that the user 114 is the primary user of the connected car 112, the customization client 118 can retrieve the primary user profile 134 and provide the primary user profile 134 to the VCU 122 to customize or maintain customization of the connected car 112 for the primary user/user 114. The primary user profile 134 can be stored at the connected car 112, or the customization client 118 can query the customization service system 102 for a user profile associated with the primary user/user 114 and relevant to the connected car 112.

If, on the other hand, a determination is made, based on the comparison, that the user 114 is not the primary user of the connected car 112 but is a secondary user instead, the customization client 118 can query the customization service system 102 for a user profile, such as one or more of the user profiles 104A-104N, associated with the user 114 and relevant to the connected car 112. Considering that the user profile 104A of the user profiles 104A-104N is determined to be associated with the user 114 and is relevant to the connected car 112, the customization client 118 can receive the user profile 104A from the customization service system 102 and, according to embodiments, compare the user profile 104A to the primary user profile 134 of the primary user. If a determination is made that the information that can be used to manage settings of one or more components of the connected car 112 from the user profile 104A does not exceed the settings of one or more components set forth by the primary user profile 134, the customization client 118 can provide the user profile 104A to the VCU 122 to temporarily customize one or more components of the connected car 112 for the user 114.

If a determination is made that any of the information that can be used to manage settings of one or more components of the connected car 112 from the user profile 104A exceeds the settings of one or more components set forth by the primary user profile 134, the customization client 118 can determine whether the user 114 is part of a user exception group. As discussed further below, members of a user exception group may be allowed to override any limits/parameters/rules set forth by the primary user profile 134 and, in some instances, extend functionality of the connected car 112 beyond that provided to the primary user. For example, if the user profile 104A allows connection to a first responder network only accessible by emergency personnel, such as FIRSTNET provided by AT&T, but the connected car 112 is a civilian vehicle evidenced by the primary user profile 134 not including authorization to connect to FIRSTNET, the customization client 118 can determine whether the user 114 is part of a user exception group. According to embodiments, the user exception group includes emergency personnel (e.g., police officers, firefighters, emergency medical service members, and first responders), government officials, and/or other users identified by the primary user that are mandated or allowed to have unrestricted access to a shared space, such as the connected car 112. Information indicating whether a user is part of a user exception group may be found in a user profile associated with the user, may be provided by the user, and/or may be received from a device associated with the user. The information may include a badge number, medical license number, government identification information, or any another information that could be used to identify the user as being part of the user exception group. If the customization client 118 determines that the user 114 is part of the user exception group, the customization client 118 can provide the user profile 104A to the VCU 122 to apply the settings of the user profile 104A to temporarily replace the settings of the primary user profile 134 with those of the user profile 104A in order to customize the connected car 112 for the user 114. If, on the other hand, the customization client 118 determines that the user 114 is not a member of the user exception group, the customization client 118 can provide the user profile 104A to the VCU 122 with instructions to limit the adjustment of settings of components of the connected car 112 to those of the user profile 104A that do not exceed the primary user profile 134 to partially customize the connected car for the user 114.

Based on the instructions received from the customization client 118 and the information of the user profile 104A, the VCU 122 instructs one or more of the ECUs 120, the TCU 124, the infotainment unit 126, and/or any other controller of the connected car 112 to apply adjustments to one or more components of the connected car 112 provided by the user profile 104A to at least partially customize the connected car 112 for the user 114. According to embodiments, one or more components of the connected car 112 that can be adjusted based on the user profile 104A can include climate control settings, lighting levels, seating arrangement, seat settings, media playback preferences, radio presets, navigation history, driver assistance system preferences, preferences for receiving notifications, alerts, and updates, preferred communication channels, language preferences, security preference settings for accessing and securing the connected car 112 including authentication methods and access control settings, privacy preference settings related to data sharing and usage within the connected car 112 including consent for data collection, sharing preferences with others users, and privacy controls for personal information, billing and payment settings including billing and payment preferences and methods for managing expenses associated with the connected car 112, networking preferences within the connected car 112, and/or any other customizable setting associated with the connected car 112. In some cases, when a user profile, such as the user profile 104A, has been successfully applied, the connected car 112 may indicate to the user 114 that the user profile 104A has been successfully applied. For example, a textual and/or pictorial indication may be displayed on a console display of the infotainment unit 126 of the connected car 112 and/or transmitted to a user device, such as the user device 128, associated with the user 114 for display by the user device 128.

While the connected car 112 is customized based on the user profile 104A of the user 114, any actions associated with the connected car 112 that incur a fee are billed to the user 114. For example, any tolls, parking violations, and/or traffic violations received while the connected car 112 is customized based on the user profile 104A are billed to the user 114. Similarly, any purchases/upgrades associated with the connected car 112 while customized based on the user profile 104A are billed to the user 114. According to embodiments, billing and/or payment settings provided by the user profile 104A can be used to direct any fees incurred to the user 114.

In response to the customization client 118 no longer detecting the user 114 in association with the connected car 112, the customization client 118 can instruct the VCU 122 to adjust the one or more components of the connected car 112 back to the settings of the primary user profile 134. For instance, in response to detecting that the user 114 has logged out of the customization client 118, that the user 114 is no longer detectable by one or more sensors of the connected car 112, and/or that one or more devices associated with the user 114 are no longer paired with the connected car 112, the customization client 118 can instruct the VCU 122 to adjust the one or more components of the connected car 112 back to the settings of the primary user profile 134 to customize the connected car 112 for the primary user. Alternatively, the customization client 118 may hold off on instructing the VCU 122 to apply any new adjustments to the components of the connected car 112 until the customization client 118 detects another user in association with the connected car 112. The customization client 118 can also instruct one or more of the ECUs 120, the TCU 124, the infotainment unit 126, and/or any other controller of the connected car 112 to provide the primary owner of the connected car 112 applicable vehicle records (e.g., camera records, speed records, mileage, user profile violations, etc.) from when the connected car 112 was customized for the user 114.

FIG. 1 illustrates one customization service system 102, one cloud network 116, one connected car 112, one user 114, and one user device 128. It should be understood, however, that various implementations of the operating environment 100 can include one or more than one customization service system 102; one or more than one cloud network 116; one or more than one connected car 112, one or more than one user 114, and one or more than one user device 128. As such, the illustrated embodiment should be understood as being illustrative, and should not be construed as being limiting in any way.

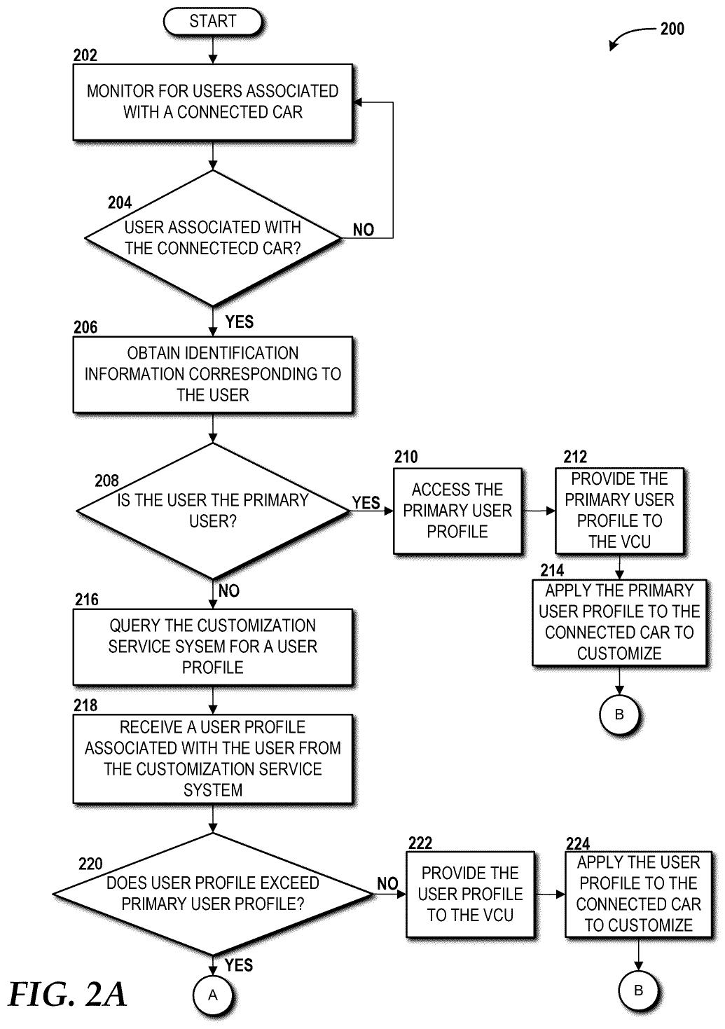

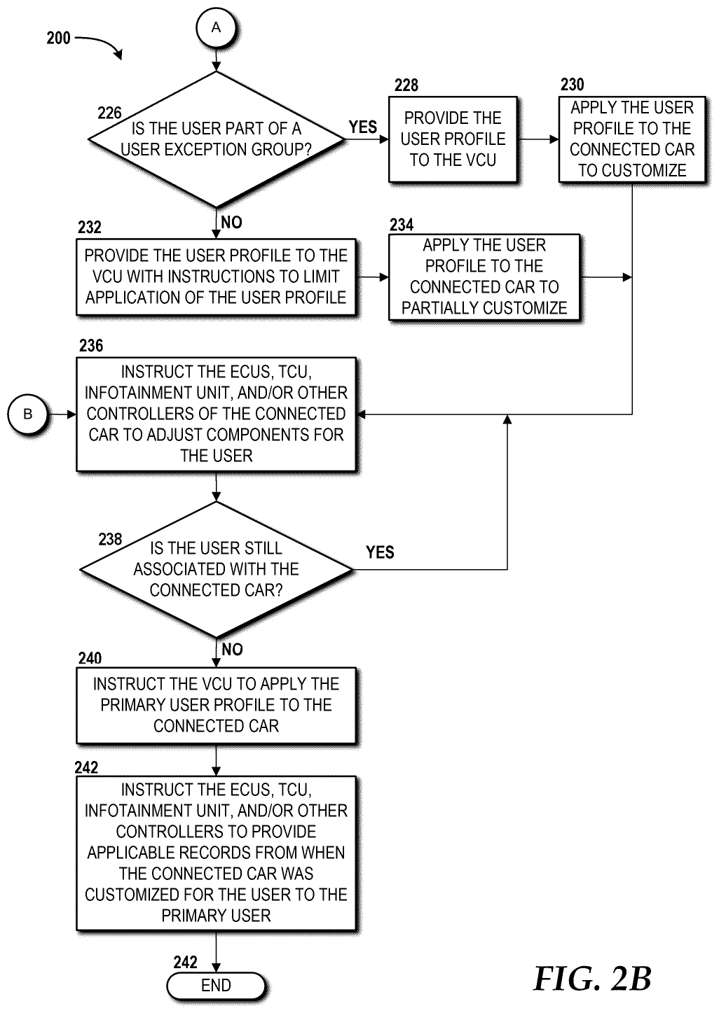

Turning now to FIGS. 2A-2B, flow diagrams illustrating aspects of a method 200 for customizing a shared space, such as the connected car 112, based on a user profile, will be described, according to an illustrative embodiment of the concepts and technologies disclosed herein. It should be understood that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the concepts and technologies disclosed herein.

It also should be understood that the methods disclosed herein can be ended at any time and need not be performed in its entirety. Some or all operations of the methods, and/or substantially equivalent operations, can be performed by execution of computer-readable instructions included on a computer storage media, as defined herein. The term “computer-readable instructions,” and variants thereof, as used herein, is used expansively to include routines, applications, application modules, program modules, programs, components, data structures, algorithms, and the like. Computer-readable instructions can be implemented on various system configurations including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These states, operations, structural devices, acts, and modules may be implemented in software, in firmware, in special purpose digital logic, and any combination thereof. As used herein, the phrase “cause a processor to perform operations” and variants thereof is used to refer to causing a processor of a computing system or device, or a portion thereof, to perform one or more operations, and/or causing the processor to direct other components of the computing system or device to perform one or more of the operations.

For purposes of illustrating and describing the concepts of the present disclosure, operations of the methods disclosed herein are described as being performed alone or in combination via execution of one or more software modules, and/or other software/firmware components described herein. It should be understood that additional and/or alternative devices and/or network nodes can provide the functionality described herein via execution of one or more modules, applications, and/or other software. Thus, the illustrated embodiments are illustrative, and should not be viewed as being limiting in any way.

The method 200 will be described with additional reference to FIG. 1. The method 200 begins and proceeds to operation 202, where a shared space, such as the connected car 112, monitors for users associated with the connected car 112. From operation 202, the method 200 proceeds to operation 204, where the connected car 112 determines whether a user, such as the user 114, is associated with the connected car 112. The user 114 may be determined to be associated with the connected car 112 in response to the connected car 112 detecting, via one or more medium-range and/or short-range communication protocols, the user device 128 of the user 114 in proximity to the connected car 112. The user 114 may also be determined to be associated with the connected car 112 in response to the user 114 registering to use/rent the connected car 112, in response to the user 114 providing input to the connected car 112 either via a user interface provided by the connected car 112 or the user device 128, in response to one or more sensors of the connected car 112 capturing biometric data associated with the user 114, and/or any other method of determining an association between the user 114 and the connected car 112.

If a determination is made that a user is not associated with the connected car 112, the method 200 proceeds back to operation 202, where the connected car 112 continues to monitor for users associated with the connected car 112. If, on the other hand, a determination is made that a user is associated with the connected car, the method 200 proceeds from operation 204 to operation 206, where the customization client 118 executing on the connected car 112 can obtain identification information corresponding to the user 114. For example, the user 114 may provide identification information to a user interface provided by a display of the connected car 112 and/or a user interface provided by a display of the user device 128, which can then be communicated to the connected car 112 and received by the customization client 118. Moreover, the connected car 112 may pair with one or more wearable devices (not shown) associated with the user 114 to extract identification information corresponding to the user 114 that is then provided to the customization client 118.

From operation 206, the method 200 proceeds to operation 208, where the customization client 118 can use the identification information to determine whether the user 114 is a primary user or secondary user of the connected car 112. According to embodiments, the customization client 118 can compare the identification information corresponding to the user 114 with information identifying the primary user from the primary user data 132. If a determination is made that the user 114 is the primary user of the connected car 112, based on the identification information of the user 114 matching information identifying the primary user from the primary user data 132, the method 200 proceeds from operation 208 to operation 210, where the customization client 118 can access the primary user profile 134. From operation 210, the method 200 proceeds to operation 212, where the customization client 118 provides the primary user profile 134 to the VCU 122 with instructions to apply the primary user profile 134 to the connected car 112. From operation 212, the method 200 proceeds to operation 214, where the VCU 122 customizes or maintains customization of the connected car 112 for the primary user/user 114 by applying the preferences/parameters of the primary user profile 134 to one or more components of the connected car 112.

Turning back to operation 208, if a determination is made that the user 114 is not the primary user of the connected car 112 but is a secondary user instead, based on the identification information of the user 114 not matching information identifying the primary user, the method 200 proceeds from operation 208 to operation 216, where the customization client 118 can query the customization service system 102 for a user profile, such as one of the user profiles 104A-104N, associated with the user 114 and relevant to the connected car 112. From operation 216, the method 200 proceeds to operation 218, where the customization client 118 receives a user profile associated with the user 114, such as the user profile 104A, from the customization service system 102. From operation 218, the method 200 proceeds to operation 220, where the customization client 118 compares the user profile 104A to the primary user profile 134 of the primary user to determine if the information from the user profile 104A exceeds the settings of the primary user profile 134. If a determination is made that the information from the user profile 104A that can be used to manage settings of one or more components of the connected car 112 does not exceed the settings of one or more components set forth by the primary user profile 134, the method 200 proceeds from operation 220 to operation 222, where the customization client 118 can provide the user profile 104A to the VCU 122 with instructions to apply the user profile 104A to the connected car 112. From operation 222, the method 200 proceeds to operation 224, where the VCU 122 temporarily customizes one or more components of the connected car 112 for the user 114 by applying the preferences/parameters of the user profile 104A to one or more components of the connected car 112.

Returning to operation 220, if a determination is made that any of the information from the user profile 104A that can be used to manage settings of one or more components of the connected car 112 exceeds the settings of one or more components set forth by the primary user profile 134, the method 200 proceeds to operation 226, where the customization client 118 can determine whether the user 114 is part of a user exception group that, as discussed above, is allowed to exceed the parameters/preferences set forth by the primary user profile 134. According to embodiments, a user profile, such as the user profile 104A, can be determined to exceed the primary user profile 134 if the parameters/preferences set forth by the user profile 104A give the user 114 a level of access and/or capability that goes beyond that given the primary user based on the primary user profile 134. For instance, if the primary user profile 134 limits the maximum speed of the connected car 112 to 75 mph, the user profile 104A exceeds the primary user profile 134 if the user profile 104A allows a maximum speed of 85 mph. If, at operation 226, the customization client 118 determines that the user 114 is part of the user exception group, the method 200 proceeds to operation 228, where the customization client 118 can provide the user profile 104A to the VCU 122 with instructions to apply the user profile 104A to the connected car 112. From operation 228, the method 200 proceeds to operation 230, where the VCU temporarily customizes one or more components of the connected car 112 for the user 114 by applying the preferences/parameters of the user profile 104A to one or more components of the connected car 112.

Returning to operation 226, if the customization client 118 determines that the user 114 is not part of the user exception group at operation 224, the method 200 proceeds to operation 232, where the customization client 118 can provide the user profile 104A to the VCU 122 with instructions to limit the adjustment of settings of components of the connected car 112 to those of the user profile 104A that do not exceed the primary user profile 134 to partially customize the connected car for the user 114. From operation 232 the method 200 proceeds to operation 234, where the VCU 122 temporarily customizes one or more components of the connected car 112 for the user 114 by applying the preferences/parameters of the user profile 104A that do not exceed the primary user profile 134 to one or more components of the connected car 112, causing the connected car 112 to be partially customized for the user 114.

From operations 214, 224, 230, or 234, the method 200 proceeds to operation 236, where the VCU 122 instructs one or more of the ECUs 120, the TCU 124, the infotainment unit 126, and/or any other controller of the connected car 112 to adjust one or more components of the connected car 112 to at least partially customize the connected car 112 for the user 114 based on the instructions received from the customization client 118 and the information of the user profile 104A. From operation 236, the method 200 proceeds to operation 238, where the customization client 118 determines if the user 114 is still associated with the connected car 112. For instance, the customization client 118 can determine whether the user 114 has logged out of the customization client 118, whether the user 114 is no longer detectable by one or more sensors of the connected car 112, and/or whether one or more devices associated with the user 114 are no longer paired with the connected car 112. In response to determining that the user 114 is still associated with the connected car, the method 200 proceeds back to operation 236, where the VCU 122 continues to instruct one or more of the ECUs 120, the TCU 124, the infotainment unit 126, and/or any other controller of the connected car 112 to adjust one or more components of the connected car 112 to at least partially customize the connected car 112 for the user 114 based on the instructions received from the customization client 118 and the information of the user profile 104A. On the other hand, in response to determining that the user 114 is no longer associated with the connected car 112, the method 200 proceeds from operation 238 to operation 240, where the customization client 118 instructs the VCU 122 to apply the primary user profile 134 in order to adjust the one or more components of the connected car 112 back to the settings of the primary user profile 134 to customize the connected car 112 for the primary user. Alternatively, the customization client 118 may hold off on instructing the VCU 122 to apply any new adjustments to the components of the connected car 112 until the customization client 118 detects another user in association with the connected car 112. From operation 240, the method 200 proceeds to operation 242, where the customization client 118 can also instruct one or more of the ECUs 120, the TCU 124, the infotainment unit 126, and/or any other controller of the connected car 112 to provide the primary user of the connected car 112 applicable vehicle records (e.g., camera records, speed records, mileage, user profile violations, etc.) from when the connected car 112 was customized for the user 114. From operation 242, the method 200 proceeds to operation 244, where the method 200 ends.

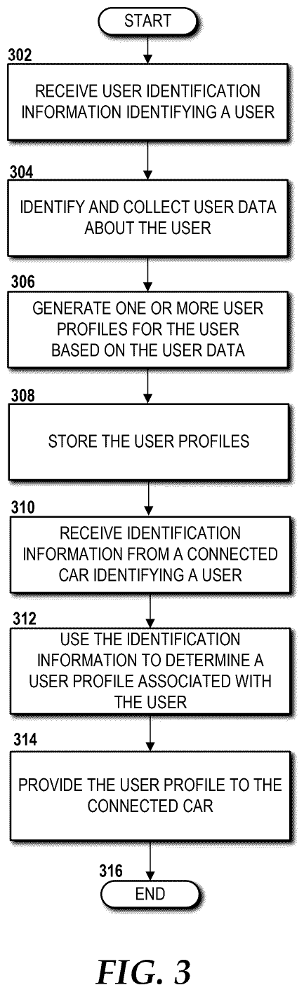

Turning now to FIG. 3, a flow diagram illustrating aspects of a method 300 for generating and managing user profiles for customizing a shared space, such as the connected car 112, will be described, according to an illustrative embodiment of the concepts and technologies disclosed herein. It should be understood that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the concepts and technologies disclosed herein.

The method 300 will be described with additional reference to FIG. 1. The method 300 begins and proceeds to operation 302, where the profile aggregator 106 of the customization service system 102 can receive user identification information identifying a user, such as the user 114, for which user data should be collected. The profile aggregator 106 may receive user identification information associated with a user when the user registers for the shared space customization service provided by the customization service system 102, through an authentication process associated with the customization service system 102, through interaction with the customization service system 102 by a device associated with the user, and/or any other method of receiving or inferring user identification information associated with a user.

From operation 302, the method 300 proceeds to operation 304, where the profile aggregator 106 identifies and collects, from the data sources 110A-110N, user data about the user identified from the user identification information received. The profile aggregator 106 can focus on collecting user data associated with identification information that matches at least a portion of the received user identification information of a user, such as the user 114, and that is related to and/or relevant to the operation, usage, and maintenance of a shared space in order to generate user profiles, such as the user profiles 104A-104B, that are pertinent to the shared space. From operation 304, the method 300 proceeds to operation 306, where the profile aggregator 106 filters and processes the user data collected to generate one or more user profiles, such as the user profiles 104A-104N, for the user. One or more of the user profiles 104A-104N generated by the profile aggregator 106 associated with the user can include information tailored to manage settings of one or more shared spaces so as to customize the shared space for the particular user. Accordingly, a user, such as the user 114, can be associated with a specific user profile for each of a plurality of shared spaces (e.g., connected car, smart home, shared office, etc.). The profile aggregator 106 can continue to manage and update the user profiles 104A-104N after they are generated.

From operation 306, the method 300 proceeds to operation 308, where the profile aggregator 106 stores the one or more user profiles 104A-104N in the profile repository 108. From operation 308, the method 300 proceeds to operation 310, where the profile aggregator 106 receives identification information from a shared space, such as the connected car 112, identifying a user, such as the user 114, determined to be associated with the connected car 112. From operation 310, the method 300 proceeds to operation 312, where the profile aggregator 106 uses the identification information received from the connected car 112 to determine one or more of the user profiles 104A-104N associated with the user 114 and relevant to the connected car 112. From operation 312, the method 300 proceeds to operation 314, where the one or more of the user profiles 104A-104N determined to be associated with the user 114 and relevant to the connected car 112 are provided to the connected car 112 by the customization service system 102 via the communications network 130. From operation 314, the method 300, proceeds to operation 316, where the method 300 ends.

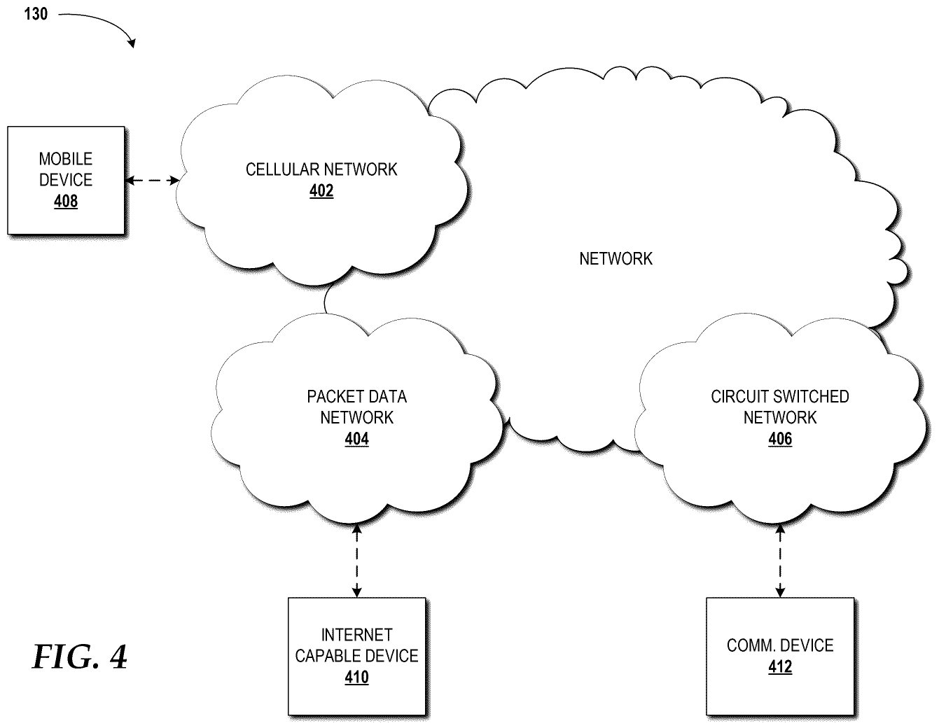

Turning now to FIG. 4, additional details of the communications network 130 are illustrated, according to an illustrative embodiment. The communications network 130 includes a cellular network 402, a packet data network 404, for example, the Internet, and a circuit switched network 406, for example, a publicly switched telephone network (“PSTN”). The cellular network 402 includes various components such as, but not limited to, base transceiver stations (“BTSs”), NodeB's or eNodeB's (“eNBs”), gNodeBs (“gNBs”), or the like; base station controllers (“BSCs”) radio network controllers (“RNCs”), or the like; an evolved packet core (“EPC”); mobile switching centers (“MSCs” or “MSSs”); session management functions (“SMFs); mobile management entities (” MMEs “); access and mobility management functions (” AMFs); authentication server functions (“AUSFs”), network slice selection functions (“NSSFs); network exposure functions (” NEFs “); policy control functions (” PCFs “); and various other functions in the user and control planes such as, for example, user plane functions (” UPFs), application functions (“AFs”), NF repository functions (“NRFs”), and the like; short message service centers (“SMSCs”); multimedia messaging service centers (“MMSCs”); home location registers (“HLRs”); home subscriber servers (“HSSs”); visitor location registers (“VLRs”); charging platforms; billing platforms; voicemail platforms; GPRS core network components; links to data networks (“DNs”) and/or other operator services, third party services, and/or the Internet; location service nodes, an IP Multimedia Subsystem (“IMS”); and the like. Of course, the cellular network 402 also can include various interfaces between various components, as is generally understood. The cellular network 402 also includes radios and nodes for receiving and transmitting voice, data, and combinations thereof to and from radio transceivers, networks, the packet data network 404, and the circuit switched network 406.

A mobile communications device 408, such as, for example, a cellular telephone, a user equipment, a mobile terminal, a PDA, a laptop computer, a handheld computer, and combinations thereof, can be operatively connected to the cellular network 402. The cellular network 402 can be configured as a 2G GSM network and can provide data communications via GPRS and/or EDGE. Additionally, or alternatively, the cellular network 402 can be configured as a 3G UMTS network and can provide data communications via the HSPA protocol family, for example, HSDPA, EUL (also referred to as HSUPA), and HSPA+. The cellular network 402 also is compatible with 4G mobile communications standards, 5G mobile communications standards, 6G mobile communication standards, other mobile communications standards, and evolved and future mobile communications standards.

The packet data network 404 includes various devices, for example, servers, computers, databases, and other devices in communication with one another, as is generally known. The packet data network 404 devices are accessible via one or more network links. The servers often store various files that are provided to a requesting device such as, for example, a computer, a terminal, a smartphone, or the like. Typically, the requesting device includes software (a “browser”) for executing a web page in a format readable by the browser or other software. Other files and/or data may be accessible via “links” in the retrieved files, as is generally known. In some embodiments, the packet data network 404 includes or is in communication with the Internet. The circuit switched network 406 includes various hardware and software for providing circuit switched communications. The circuit switched network 406 may include, or may be, what is often referred to as a plain old telephone system (POTS). The functionality of a circuit switched network 406 or other circuit-switched network are generally known and will not be described herein in detail.

The illustrated cellular network 402 is shown in communication with the packet data network 404 and a circuit switched network 406, though it should be appreciated that this is not necessarily the case. One or more Internet-capable devices 410, for example, a PC, a laptop, a portable device, or another suitable device, can communicate with one or more cellular networks 402, and devices connected thereto, through the packet data network 404. It also should be appreciated that the Internet-capable device 410 can communicate with the packet data network 404 through the circuit switched network 406, the cellular network 402, and/or via other networks (not illustrated).

As illustrated, a communications device 412, for example, a telephone, facsimile machine, modem, computer, or the like, can be in communication with the circuit switched network 406, and therethrough to the packet data network 404 and/or the cellular network 402. It should be appreciated that the communications device 412 can be an Internet-capable device, and can be substantially similar to the Internet-capable device 410. In the specification, the network 104 is used to refer broadly to any combination of the networks 402, 404, 406. It should be appreciated that substantially all of the functionality described with reference to the communications network 130 can be performed by the cellular network 402, the packet data network 404, and/or the circuit switched network 406, alone or in combination with other networks, network elements, and the like.

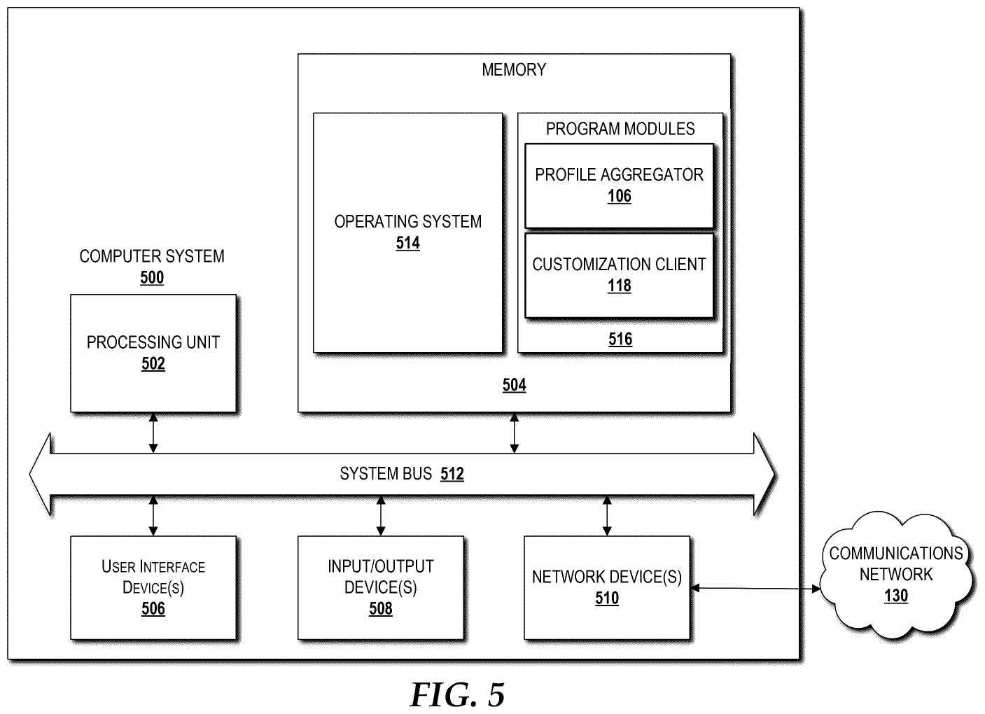

FIG. 5 is a block diagram illustrating a computer system 500 configured to provide the functionality described herein for providing a customization service system that collects, aggregates, and manages user data from multiple sources to create and maintain user profiles that can be applied to a shared space for customization of at least one characteristic of the shared space, in accordance with various embodiments of the concepts and technologies disclosed herein. The systems, devices, and other components disclosed herein, such as the customization service system 102, the data sources 110A-110N, components of the connected car 112, components of the communications network 130, components of the cloud network 116, or some combination thereof can be implemented, at least in part, using an architecture that is the same as or similar to the architecture of the computer system 500. The computer system 500 includes a processing unit 502, a memory 504, one or more user interface devices 506, one or more input/output (“I/O”) devices 508, and one or more network devices 510, each of which is operatively connected to a system bus 512. The system bus 512 can enable bi-directional communication between the processing unit 502, the memory 504, the user interface devices 506, the I/O devices 508, and the network devices 510.

The processing unit 502 may be a standard central processor that performs arithmetic and logical operations, a more specific purpose programmable logic controller (“PLC”), a programmable gate array, or other type of processor known to those skilled in the art and suitable for controlling the operation of the server computer. As used herein, the word “processor” and/or the phrase “processing unit” when used with regard to any architecture or system can include multiple processors or processing units distributed across and/or operating in parallel in a single machine or in multiple machines. Furthermore, processors and/or processing units can be used to support virtual processing environments. Processors and processing units also can include state machines, application-specific integrated circuits (“ASICs”), combinations thereof, or the like. Because processors and/or processing units are generally known, the processors and processing units disclosed herein will not be described in further detail herein.

The memory 504 communicates with the processing unit 502 via the system bus 512. In some embodiments, the memory 504 is operatively connected to a memory controller (not shown) that enables communication with the processing unit 502 via the system bus 512. The memory 504 includes an operating system 514 and one or more program modules 516. The operating system 514 can include, but is not limited to, members of the WINDOWS, WINDOWS CE, and/or WINDOWS MOBILE families of operating systems from MICROSOFT CORPORATION, the LINUX family of operating systems, the SYMBIAN family of operating systems from SYMBIAN LIMITED, the BREW family of operating systems from QUALCOMM CORPORATION, the MAC OS, iOS, and/or SONOMA families of operating systems from APPLE CORPORATION, the FREEBSD family of operating systems, the SOLARIS family of operating systems from ORACLE CORPORATION, other operating systems, and the like.

The program modules 516 may include various software and/or program modules described herein. In some embodiments, for example, the program modules 516 include the profile aggregator 106 and the customization client 118. These and/or other programs can be embodied in computer-readable media containing instructions that, when executed by the processing unit 502, perform one or more of the methods 200 and 300 described in detail above with respect to FIGS. 2A-3 and/or other functionality as illustrated and described herein. It can be appreciated that, at least by virtue of the instructions embodying the methods 200 and 300 and/or other functionality illustrated and described herein being stored in the memory 504 and/or accessed and/or executed by the processing unit 502, the computer system 500 is a special-purpose computing system that can facilitate providing the functionality illustrated and described herein. According to embodiments, the program modules 516 may be embodied in hardware, software, firmware, or any combination thereof. Although not shown in FIG. 5, it should be understood that the memory 504 also can be configured to store the user profiles 104A-104N, the primary user data 132, the primary user profile 134 and/or other data, if desired.

By way of example, and not limitation, computer-readable media may include any available computer storage media or communication media that can be accessed by the computer system 500. Communication media includes computer-readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Computer storage media includes only non-transitory embodiments of computer readable media as illustrated and described herein. Thus, computer storage media can include volatile and non-volatile, removable and non-removable media implemented in any method or technology for storage of information such as computer-readable instructions, data structures, program modules, or other data. Computer storage media includes, but is not limited to, RAM, ROM, Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer system 500. In the claims, the phrase “computer storage medium” and variations thereof does not include waves or signals per se and/or communication media.

The user interface devices 506 may include one or more devices with which a user accesses the computer system 500. The user interface devices 506 may include, but are not limited to, computers, servers, personal digital assistants, cellular phones, or any suitable computing devices. The I/O devices 508 enable a user to interface with the program modules 516. In one embodiment, the I/O devices 508 are operatively connected to an I/O controller (not shown) that enables communication with the processing unit 502 via the system bus 512. The I/O devices 508 may include one or more input devices, such as, but not limited to, a keyboard, a mouse, or an electronic stylus. Further, the I/O devices 508 may include one or more output devices, such as, but not limited to, a display screen or a printer.

The network devices 510 enable the computer system 500 to communicate with other networks or remote systems via a network, such as the communications network 130. Examples of the network devices 510 include, but are not limited to, a modem, a radio frequency (“RF”) or infrared (“IR”) transceiver, a telephonic interface, a bridge, a router, or a network card. The communications network 130 may include a wireless network such as, but not limited to, a Wireless Local Area Network (“WLAN”) such as a WI-FI network, a Wireless Wide Area Network (“WWAN”), a Wireless Personal Area Network (“WPAN”) such as BLUETOOTH, a Wireless Metropolitan Area Network (“WMAN”) such as a WiMAX network, or a cellular network. Alternatively, the network 104 may be a wired network such as, but not limited to, a Wide Area Network (“WAN”) such as the Internet, a Local Area Network (“LAN”) such as the Ethernet, a wired Personal Area Network (“PAN”), or a wired Metropolitan Area Network (“MAN”).

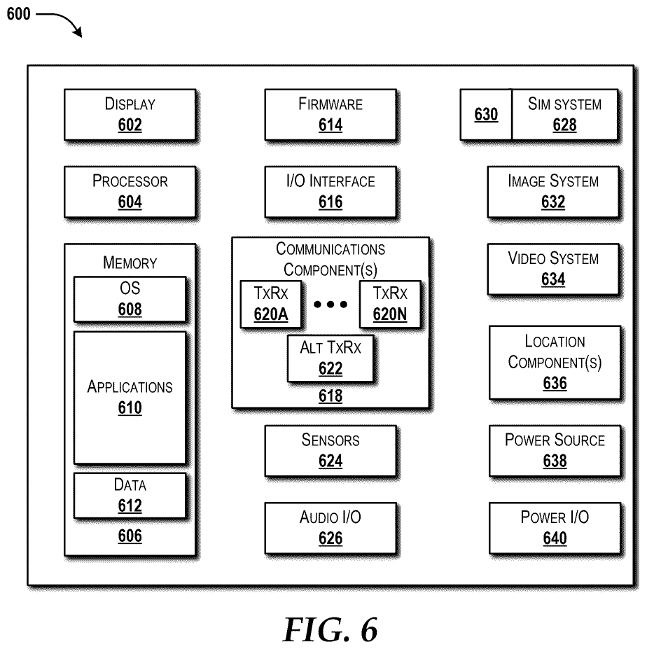

Turning now to FIG. 6, an illustrative mobile device 600 and components thereof will be described. In some embodiments, the user device 128 described above with reference to FIG. 1 can be configured as and/or can have an architecture similar or identical to the mobile device 600 described herein in FIG. 6. It should be understood, however, that the user device 128 may or may not include the functionality described herein with reference to FIG. 6. While connections are not shown between the various components illustrated in FIG. 6, it should be understood that some, none, or all of the components illustrated in FIG. 6 can be configured to interact with one another to carry out various device functions. In some embodiments, the components are arranged so as to communicate via one or more busses (not shown). Thus, it should be understood that FIG. 6 and the following description are intended to provide a general understanding of a suitable environment in which various aspects of embodiments can be implemented, and should not be construed as being limiting in any way.

As illustrated in FIG. 6, the mobile device 600 can include a display 602 for displaying data. According to various embodiments, the display 602 can be configured to display various graphical user interface (“GUI”) elements such as, for example, device names, login information, passwords, text, images, video, virtual keypads and/or keyboards, messaging data, notification messages, metadata, internet content, device status, time, date, calendar data, device preferences, map and location data, combinations thereof, and/or the like. The mobile device 600 also can include a processor 604 and a memory or other data storage device (“memory”) 606. The processor 604 can be configured to process data and/or can execute computer-executable instructions stored in the memory 606. The computer-executable instructions executed by the processor 604 can include, for example, an operating system 608, one or more applications 610, other computer-executable instructions stored in a memory 606, or the like. In some embodiments, the applications 610 also can include a UI application (not illustrated in FIG. 6).

The UI application can interface with the operating system 608 to facilitate user interaction with functionality and/or data stored at the mobile device 600 and/or stored elsewhere. In some embodiments, the operating system 608 can include a member of the SYMBIAN OS family of operating systems from SYMBIAN LIMITED, a member of the WINDOWS MOBILE OS and/or WINDOWS PHONE OS families of operating systems from MICROSOFT CORPORATION, a member of the PALM WEBOS family of operating systems from HEWLETT PACKARD CORPORATION, a member of the BLACKBERRY OS family of operating systems from RESEARCH IN MOTION LIMITED, a member of the IOS family of operating systems from APPLE INC., a member of the ANDROID OS family of operating systems from GOOGLE INC., and/or other operating systems. These operating systems are merely illustrative of some contemplated operating systems that may be used in accordance with various embodiments of the concepts and technologies described herein and therefore should not be construed as being limiting in any way.

The UI application can be executed by the processor 604 to aid a user in entering content, creating device names, creating passwords, creating logins, selecting connections, requesting temporary connections, configuring settings, manipulating address book content and/or settings, multimode interaction, interacting with other applications 610, and otherwise facilitating user interaction with the operating system 608, the applications 610, and/or other types or instances of data 612 that can be stored at the mobile device 600. The data 612 can include applications or program modules. According to various embodiments, the data 612 can include, for example, presence applications, visual voice mail applications, messaging applications, text-to-speech and speech-to-text applications, add-ons, plug-ins, email applications, music applications, video applications, camera applications, location-based service applications, power conservation applications, game applications, productivity applications, entertainment applications, enterprise applications, combinations thereof, and the like. The applications 610, the data 612, and/or portions thereof can be stored in the memory 606 and/or in a firmware 614, and can be executed by the processor 604.

It can be appreciated that, at least by virtue of storage of the instructions corresponding to the applications 610 and/or other instructions embodying other functionality illustrated and described herein in the memory 606, and/or by virtue of the instructions corresponding to the applications 610 and/or other instructions embodying other functionality illustrated and described herein being accessed and/or executed by the processor 604, the mobile device 600 is a special-purpose mobile device that can facilitate providing the functionality illustrated and described herein. The firmware 614 also can store code for execution during device power up and power down operations. It can be appreciated that the firmware 614 can be stored in a volatile or non-volatile data storage device including, but not limited to, the memory 606 and/or a portion thereof.

The mobile device 600 also can include an input/output (“I/O”) interface 616. The I/O interface 616 can be configured to support the input/output of data, user information, organization information, presence status information, user IDs, passwords, and application initiation (start-up) requests. In some embodiments, the I/O interface 616 can include a hardwire connection such as a universal serial bus (“USB”) port, a mini-USB port, a micro-USB port, an audio jack, a PS2 port, an IEEE 1394 (“FIREWIRE”) port, a serial port, a parallel port, an Ethernet (RJ45 or RJ48) port, a telephone (RJ11 or the like) port, a proprietary port, combinations thereof, or the like. In some embodiments, the mobile device 600 can be configured to synchronize with another device to transfer content to and/or from the mobile device 600. In some embodiments, the mobile device 600 can be configured to receive updates to one or more of the applications 610 via the I/O interface 616, though this is not necessarily the case. In some embodiments, the I/O interface 616 accepts I/O devices such as keyboards, keypads, mice, interface tethers, printers, plotters, external storage, touch/multi-touch screens, touch pads, trackballs, joysticks, microphones, remote control devices, displays, projectors, medical equipment (e.g., stethoscopes, heart monitors, and other health metric monitors), modems, routers, external power sources, docking stations, combinations thereof, and the like. It should be appreciated that the I/O interface 616 may be used for communications between the mobile device 600 and a network device or local device.

The mobile device 600 also can include a communications component 618. The communications component 618 can be configured to interface with the processor 604 to facilitate wired and/or wireless communications with one or more networks such as the communications network 130 described herein. In some embodiments, other networks include networks that utilize non-cellular wireless technologies such as WI-FI or WIMAX. In some embodiments, the communications component 618 includes a multimode communications subsystem for facilitating communications via the cellular network and one or more other networks.

The communications component 618, in some embodiments, includes one or more transceivers. The one or more transceivers, if included, can be configured to communicate over the same and/or different wireless technology standards with respect to one another. For example, in some embodiments one or more of the transceivers of the communications component 618 may be configured to communicate using GSM, CDMAONE, CDMA2000, LTE, and various other 2G, 2.5G, 3G, 4G, 5G, 6G, and greater generation technology standards. Moreover, the communications component 618 may facilitate communications over various channel access methods (which may or may not be used by the aforementioned standards) including, but not limited to, TDMA, FDMA, W-CDMA, OFDM, SDMA, and the like.

In addition, the communications component 618 may facilitate data communications using GPRS, EDGE, the HSPA protocol family including HSDPA, EUL or otherwise termed HSUPA, HSPA+, and various other current and future wireless data access standards. In the illustrated embodiment, the communications component 618 can include a first transceiver (“TxRx”) 620A that can operate in a first communications mode (e.g., GSM). The communications component 618 also can include an Nth transceiver (“TxRx”) 620N that can operate in a second communications mode relative to the first transceiver 620A (e.g., UMTS). While two transceivers 620A-N (hereinafter collectively and/or generically referred to as “transceivers 620”) are shown in FIG. 6, it should be appreciated that less than two, two, and/or more than two transceivers 620 can be included in the communications component 618.

The communications component 618 also can include an alternative transceiver (“Alt TxRx”) 622 for supporting other types and/or standards of communications. According to various contemplated embodiments, the alternative transceiver 622 can communicate using various communications technologies such as, for example, WI-FI, WIMAX, BLUETOOTH, infrared, infrared data association (“IRDA”), near field communications (“NFC”), other RF technologies, combinations thereof, and the like. In some embodiments, the communications component 618 also can facilitate reception from terrestrial radio networks, digital satellite radio networks, internet-based radio service networks, combinations thereof, and the like. The communications component 618 can process data from a network such as the Internet, an intranet, a broadband network, a WI-FI hotspot, an Internet service provider (“ISP”), a digital subscriber line (“DSL”) provider, a broadband provider, combinations thereof, or the like.

The mobile device 600 also can include one or more sensors 624. The sensors 624 can include temperature sensors, light sensors, air quality sensors, movement sensors, orientation sensors, noise sensors, proximity sensors, or the like. As such, it should be understood that the sensors 624 can include, but are not limited to, accelerometers, magnetometers, gyroscopes, infrared sensors, noise sensors, microphones, combinations thereof, or the like. Additionally, audio capabilities for the mobile device 600 may be provided by an audio I/O component 626. The audio I/O component 626 of the mobile device 600 can include one or more speakers for the output of audio signals, one or more microphones for the collection and/or input of audio signals, and/or other audio input and/or output devices.

The illustrated mobile device 600 also can include a subscriber identity module (“SIM”) system 628. The SIM system 628 can include a universal SIM (“USIM”), a universal integrated circuit card (“UICC”) and/or other identity devices. The SIM system 628 can include and/or can be connected to or inserted into an interface such as a slot interface 630. In some embodiments, the slot interface 630 can be configured to accept insertion of other identity cards or modules for accessing various types of networks. Additionally, or alternatively, the slot interface 630 can be configured to accept multiple subscriber identity cards. Because other devices and/or modules for identifying users and/or the mobile device 600 are contemplated, it should be understood that these embodiments are illustrative, and should not be construed as being limiting in any way.

The mobile device 600 also can include an image capture and processing system 632 (“image system”). The image system 632 can be configured to capture or otherwise obtain photos, videos, and/or other visual information. As such, the image system 632 can include cameras, lenses, charge-coupled devices (“CCDs”), combinations thereof, or the like. The mobile device 600 may also include a video system 634. The video system 634 can be configured to capture, process, record, modify, and/or store video content. Photos and videos obtained using the image system 632 and the video system 634, respectively, may be added as message content to an MMS message, email message, and sent to another mobile device. The video and/or photo content also can be shared with other devices via various types of data transfers via wired and/or wireless communication devices as described herein.

The mobile device 600 also can include one or more location components 636. The location components 636 can be configured to send and/or receive signals to determine a geographic location of the mobile device 600. According to various embodiments, the location components 636 can send and/or receive signals from global positioning system (“GPS”) devices, assisted-GPS (“A-GPS”) devices, WI-FI/WIMAX and/or cellular network triangulation data, combinations thereof, and the like. The location component 636 also can be configured to communicate with the communications component 618 to retrieve triangulation data for determining a location of the mobile device 600. In some embodiments, the location component 636 can interface with cellular network nodes, telephone lines, satellites, location transmitters and/or beacons, wireless network transmitters and receivers, combinations thereof, and the like. In some embodiments, the location component 636 can include and/or can communicate with one or more of the sensors 624 such as a compass, an accelerometer, and/or a gyroscope to determine the orientation of the mobile device 600. Using the location component 636, the mobile device 600 can generate and/or receive data to identify its geographic location, or to transmit data used by other devices to determine the location of the mobile device 600. The location component 636 may include multiple components for determining the location and/or orientation of the mobile device 600.

The illustrated mobile device 600 also can include a power source 638. The power source 638 can include one or more batteries, power supplies, power cells, and/or other power subsystems including alternating current (“AC”) and/or direct current (“DC”) power devices. The power source 638 also can interface with an external power system or charging equipment via a power I/O component 640. Because the mobile device 600 can include additional and/or alternative components, the above embodiment should be understood as being illustrative of one possible operating environment for various embodiments of the concepts and technologies described herein. The described embodiment of the mobile device 600 is illustrative, and should not be construed as being limiting in any way.

FIG. 7 illustrates an illustrative architecture for a cloud computing platform 700 that can be capable of executing the software components described herein for providing a customization service system that collects, aggregates, and manages user data from multiple sources to create and maintain user profiles that can be applied to a shared space for customization of at least one characteristic of the shared space and/or for interacting with the data sources 110A-110N and the connected car 112. Thus, it can be appreciated that in some embodiments of the concepts and technologies disclosed herein, the cloud computing platform 700 illustrated in FIG. 7 can be used to provide the functionality described herein with respect to the customization service system 102.

The cloud computing platform 700 thus may be utilized to execute any aspects of the software components presented herein. Thus, according to various embodiments of the concepts and technologies disclosed herein, customization service system 102 can be implemented, at least in part, on or by elements included in the cloud computing platform 700 illustrated and described herein. Those skilled in the art will appreciate that the illustrated cloud computing platform 700 is a simplification of but only one possible implementation of an illustrative cloud computing platform, and as such, the illustrated cloud computing platform 700 should not be construed as being limiting in any way.

In the illustrated embodiment, the cloud computing platform 700 can include a hardware resource layer 702, a virtualization/control layer 704, and a virtual resource layer 706. These layers and/or other layers can be configured to cooperate with each other and/or other elements of a cloud computing platform 700 to perform operations as will be described in detail herein. While connections are shown between some of the components illustrated in FIG. 7, it should be understood that some, none, or all of the components illustrated in FIG. 7 can be configured to interact with one another to carry out various functions described herein. In some embodiments, the components are arranged so as to communicate via one or more networks such as, for example, the communications network 130 illustrated and described hereinabove (not shown in FIG. 7). Thus, it should be understood that FIG. 7 and the following description are intended to provide a general understanding of a suitable environment in which various aspects of embodiments can be implemented, and should not be construed as being limiting in any way.

The hardware resource layer 702 can provide hardware resources. In the illustrated embodiment, the hardware resources can include one or more compute resources 708, one or more memory resources 710, and one or more other resources 712. The compute resource(s) 708 can include one or more hardware components that can perform computations to process data, and/or to execute computer-executable instructions of one or more application programs, operating systems, services, and/or other software including, but not limited to, the profile aggregator 106 illustrated and described herein.

According to various embodiments, the compute resources 708 can include one or more central processing units (“CPUs”). The CPUs can be configured with one or more processing cores. In some embodiments, the compute resources 708 can include one or more graphics processing units (“GPUs”). The GPUs can be configured to accelerate operations performed by one or more CPUs, and/or to perform computations to process data, and/or to execute computer-executable instructions of one or more application programs, operating systems, and/or other software that may or may not include instructions that are specifically graphics computations and/or related to graphics computations. In some embodiments, the compute resources 708 can include one or more discrete GPUs. In some other embodiments, the compute resources 708 can include one or more CPU and/or GPU components that can be configured in accordance with a co-processing CPU/GPU computing model. Thus, it can be appreciated that in some embodiments of the compute resources 708, a sequential part of an application can execute on a CPU and a computationally-intensive part of the application can be accelerated by the GPU. It should be understood that this example is illustrative, and therefore should not be construed as being limiting in any way.

In some embodiments, the compute resources 708 also can include one or more system on a chip (“SoC”) components. It should be understood that an SoC component can operate in association with one or more other components as illustrated and described herein, for example, one or more of the memory resources 710 and/or one or more of the other resources 712. In some embodiments in which an SoC component is included, the compute resources 708 can be or can include one or more embodiments of the SNAPDRAGON brand family of SoCs, available from QUALCOMM of San Diego, California; one or more embodiment of the TEGRA brand family of SoCs, available from NVIDIA of Santa Clara, California; one or more embodiment of the HUMMINGBIRD brand family of SoCs, available from SAMSUNG of Seoul, South Korea; one or more embodiment of the Open Multimedia Application Platform (“OMAP”) family of SoCs, available from TEXAS INSTRUMENTS of Dallas, Texas; one or more customized versions of any of the above SoCs; and/or one or more other brand and/or one or more proprietary SoCs.

The compute resources 708 can be or can include one or more hardware components arranged in accordance with an ARM architecture, available for license from ARM HOLDINGS of Cambridge, United Kingdom. Alternatively, the compute resources 708 can be or can include one or more hardware components arranged in accordance with an x86 architecture, such as an architecture available from INTEL CORPORATION of Mountain View, California, and others. Those skilled in the art will appreciate the implementation of the compute resources 708 can utilize various computation architectures and/or processing architectures. As such, the various example embodiments of the compute resources 708 as mentioned hereinabove should not be construed as being limiting in any way. Rather, implementations of embodiments of the concepts and technologies disclosed herein can be implemented using compute resources 708 having any of the particular computation architecture and/or combination of computation architectures mentioned herein as well as other architectures.

Although not separately illustrated in FIG. 7, it should be understood that the compute resources 708 illustrated and described herein can host and/or execute various services, applications, portals, and/or other functionality illustrated and described herein. Thus, the compute resources 708 can host and/or can execute the profile aggregator 106 or other applications or services illustrated and described herein.

The memory resource(s) 710 can include one or more hardware components that can perform or provide storage operations, including temporary and/or permanent storage operations. In some embodiments, the memory resource(s) 710 can include volatile and/or non-volatile memory implemented in any method or technology for storage of information such as computer-readable instructions, data structures, program modules, or other data disclosed herein. Computer storage media is defined hereinabove and therefore should be understood as including, in various embodiments, random access memory (“RAM”), read-only memory (“ROM”), Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium that can be used to store data and that can be accessed by the compute resources 708, subject to the definition of “computer storage media” provided above (e.g., as excluding waves and signals per se and/or communication media as defined in this application).

Although not illustrated in FIG. 7, it should be understood that the memory resources 710 can host or store the various data illustrated and described herein including, but not limited to, the profile repository 108 and the user profiles 104A-104N, if desired. It should be understood that this example is illustrative, and therefore should not be construed as being limiting in any way.

The other resource(s) 712 can include any other hardware resources that can be utilized by the compute resources(s) 708 and/or the memory resource(s) 710 to perform operations. The other resource(s) 712 can include one or more input and/or output processors (e.g., a network interface controller and/or a wireless radio), one or more modems, one or more codec chipsets, one or more pipeline processors, one or more fast Fourier transform (“FFT”) processors, one or more digital signal processors (“DSPs”), one or more speech synthesizers, combinations thereof, or the like.

The hardware resources operating within the hardware resource layer 702 can be virtualized by one or more virtual machine monitors (“VMMs”) 714A-714N (also known as “hypervisors;” hereinafter “VMMs 714”). The VMMs 714 can operate within the virtualization/control layer 704 to manage one or more virtual resources that can reside in the virtual resource layer 706. The VMMs 714 can be or can include software, firmware, and/or hardware that alone or in combination with other software, firmware, and/or hardware, can manage one or more virtual resources operating within the virtual resource layer 706.

The virtual resources operating within the virtual resource layer 706 can include abstractions of at least a portion of the compute resources 708, the memory resources 710, the other resources 712, or any combination thereof. These abstractions are referred to herein as virtual machines (“VMs”). In the illustrated embodiment, the virtual resource layer 706 includes VMs 716A-716N (hereinafter “VMs 716”).

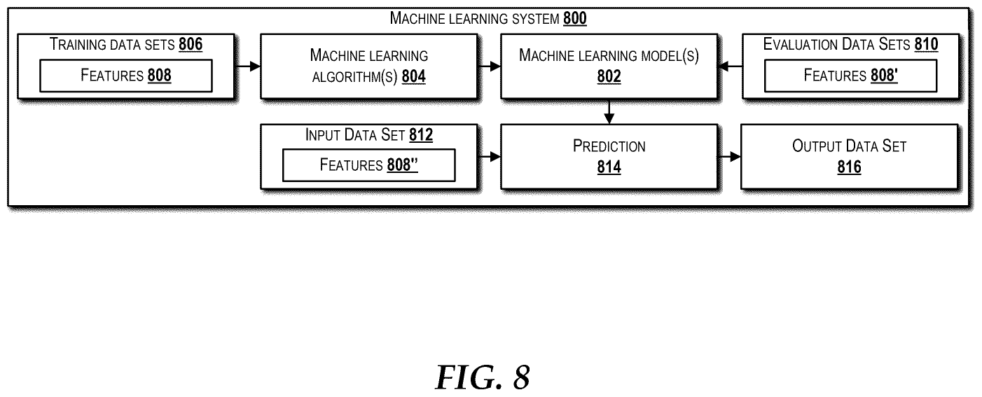

Turning now to FIG. 8, a machine learning system 800 capable of implementing aspects of the embodiments disclosed herein will be described. The machine learning system 800 can be used to train the profile aggregator 106. Accordingly, the customization service system 102 can include the machine learning system 800 or can be in communication with the machine learning system 800.

The illustrated machine learning system 800 includes one or more machine learning models 802. The machine learning models 802 can include unsupervised, supervised, and/or semi-supervised learning models. The machine learning model(s) 802 can be created by the machine learning system 800 based upon one or more machine learning algorithms 804. The machine learning algorithm(s) 804 can be any existing, well-known algorithm, any proprietary algorithms, or any future machine learning algorithm. Some example machine learning algorithms 804 include, but are not limited to, time series autoregression, Seasonal and Trend Decomposition, Seasonal and Trend Decomposition using Loess (locally estimated scatterplot smoothing), Bayesian Estimator of Abrupt Change, Seasonality, Trend (BEAST), neural networks, gradient descent, linear regression, logistic regression, linear discriminant analysis, decision trees, Naive Bayes, K-nearest neighbor, learning vector quantization, support vector machines, principal component analysis, and the like. Those skilled in the art will appreciate the applicability of various machine learning algorithms 804 based upon the problem(s) to be solved by machine learning via the machine learning system 800.

The machine learning system 800 can control the creation of the machine learning models 802 via one or more training parameters (also referred to as “tuning parameters”). In some embodiments, the training parameters are selected variables or factors at the direction of an enterprise, for example. Alternatively, in some embodiments, the training parameters are automatically selected based upon data provided in one or more training data sets 806. The training parameters can include, for example, a learning rate where relevant such as when a classification algorithm is utilized, a model size, a number of training passes, data shuffling, regularization, and/or other training parameters known to those skilled in the art.

The learning rate is a training parameter defined by a constant value. The learning rate affects the speed at which the machine learning algorithm 804 converges to the optimal weights. The machine learning algorithm 804 can update the weights for every data example included in the training data sets 806. The size of an update is controlled by the learning rate. A learning rate that is too high might prevent the machine learning algorithm 804 from converging to the optimal weights. A learning rate that is too low might result in the machine learning algorithm 804 requiring multiple training passes to converge to the optimal weights.

The model size is regulated by the number of input features (“features”) 808 in the training data sets 806. The training data sets 806 and evaluation data sets 810 discussed further below may be selected based on an appropriate training/test split for training and evaluation, such as an 80/20 split.

The number of training passes indicates the number of training passes that the machine learning algorithm 804 makes over the training data sets 806 during the training process. The number of training passes can be adjusted based, for example, on the size of the training data sets 806, with larger training data sets being exposed to fewer training passes in consideration of time and/or resource utilization. The performance of the resultant machine learning model 802 can be increased by multiple training passes.

Data shuffling is a training parameter designed to prevent the machine learning algorithm 804 from reaching false optimal weights due to the order in which data contained in the training data sets 806 is processed. For example, data provided in rows and columns might be analyzed first row, second row, third row, etc., and thus an optimal weight might be obtained well before a full range of data has been considered. By data shuffling, the data contained in the training data sets 806 can be analyzed more thoroughly and mitigate bias in the resultant machine learning model 802.

Regularization is a training parameter that helps to prevent the machine learning model 802 from memorizing training data from the training data sets 806. In other words, the machine learning model 802 fits the training data sets 806, but the predictive performance of the machine learning model 802 is not acceptable. Regularization helps the machine learning system 800 avoid this overfitting/memorization problem by adjusting extreme weight values of the features 808. For example, a feature that has a small weight value relative to the weight values of the other features in the training data sets 806 can be adjusted to zero.

The machine learning system 800 can determine model accuracy, recall, precision, receiver operating characteristic (“ROC”) area under the curve (“AUC”), and/or other desired metrics after training by using the training data sets 806 with some of the features 808 and testing the machine learning model 802 with unseen evaluation data sets 810 containing the same features 808′ in the training data sets 806. This also prevents the machine learning model 802 from simply memorizing the data contained in the training data sets 806, which can overfit the data. The optimal or desired machine learning system 800 is reached when a target model accuracy or other desired metric threshold is met, which is understood through a model evaluation process in examining model performance on the evaluation data set 810. Once a machine learning model 802 has reached the desired metric threshold or optimal performance, the machine learning model 802 is considered ready for deployment.

After deployment, the machine learning model 802 can perform a prediction operation (“prediction”) 814 with an input data set 812 having the same features 808″ as the features 808 in the training data sets 806 and the features 808′ of the evaluation data sets 810. The results of the prediction 88 are included in an output data set 816 consisting of predicted data. The machine learning model 802 can perform other operations, such as regression, classification, and others. As such, the example illustrated in FIG. 8 should not be construed as being limiting in any way.

Based on the foregoing, it should be appreciated that systems and methods for providing a customization service system that collects, aggregates, and manages user data from multiple sources to create and maintain user profiles that can be applied to a shared space for customization of at least one characteristic of the shared space have been disclosed herein. Although the subject matter presented herein has been described in language specific to computer structural features, methodological and transformative acts, specific computing machinery, and computer-readable media, it is to be understood that the concepts and technologies disclosed herein are not necessarily limited to the specific features, acts, or media described herein. Rather, the specific features, acts and mediums are disclosed as example forms of implementing the concepts and technologies disclosed herein.

The subject matter described above is provided by way of illustration only and should not be construed as limiting. Various modifications and changes may be made to the subject matter described herein without following the example embodiments and applications illustrated and described, and without departing from the true spirit and scope of the embodiments of the concepts and technologies disclosed herein.

1. A shared space comprising:
a processor; and
a memory that stores computer-executable instructions and a customization client that, when executed by the processor, cause the processor to perform operations comprising
obtaining identification information corresponding to a user associated with the shared space,
determining, based at least in part on the identification information, if the user is a primary user of the shared space,
in response to determining that the user is not the primary user of the shared space, receiving a user profile associated with the user from a customization service system, and
instructing a control unit of the shared space to apply the user profile to the shared space to customize the shared space based on the user profile, wherein applying the user profile to the shared space comprises adjusting at least one component of the shared space based on the user profile.

2. The shared space of claim 1, wherein the operations further comprise in response to determining that the user is the primary user of the shared space, providing a primary user profile associated with the primary user to the control unit of the shared space to customize the shared space based on the primary user profile.

3. The shared space of claim 1, wherein the primary user is associated with a primary user profile, and wherein the operations further comprise:
comparing the user profile to the primary user profile to determine if the user profile exceeds the primary user profile; and
in response to determining that the user profile does not exceed the primary user profile, instructing the control unit of the shared space to apply the user profile to the shared space to customize the shared space based on the user profile.

4. The shared space of claim 3, wherein the operations further comprise:
in response to determining that the user profile does exceed the primary user profile, determining whether the user is a member of a user exception group; and
in response to determining that the user is a member of the user exception group, instructing the control unit of the shared space to apply the user profile to the shared space to customize the shared space based on the user profile.

5. The shared space of claim 4, wherein instructing the control unit of the shared space to apply the user profile to the shared space to customize the shared space based on the user profile comprises instructing, in response to determining that the user is not a member of the user exception group, the control unit of the shared space to apply portions of the user profile that do not exceed the primary user profile to the shared space to customize the shared space.

6. The shared space of claim 1, wherein the customization service system comprises a profile aggregator that generates the user profile based on user data received from a plurality of data sources.

7. The shared space of claim 1, wherein the primary user is associated with a primary user profile, and wherein the operations further comprise:
determining whether the user remains associated with the shared space; and
in response to determining that the user does not remain associated with the shared space, instructing the control unit of the shared space to apply the primary user profile to the shared space to customize the shared space based on the primary user profile.

8. A method comprising:
obtaining, by a shared space comprising a processor executing a customization client, identification information corresponding to a user associated with the shared space;
determining, by the shared space, based at least in part on the identification information, if the user is a primary user of the shared space;
in response to determining that the user is not the primary user of the shared space, receiving, by the shared space, a user profile associated with the user from a customization service system; and
instructing, by the shared space, a control unit of the shared space to apply the user profile to the shared space to customize the shared space based on the user profile, wherein applying the user profile to the shared space comprises adjusting at least one component of the shared space based on the user profile.

9. The method of claim 8, further comprising in response to determining that the user is the primary user of the shared space, providing a primary user profile associated with the primary user to the control unit of the shared space to customize the shared space based on the primary user profile.

10. The method of claim 8, wherein the primary user is associated with a primary user profile, and wherein the method further comprises:
comparing the user profile to the primary user profile to determine if the user profile exceeds the primary user profile; and
in response to determining that the user profile does not exceed the primary user profile, instructing the control unit of the shared space to apply the user profile to the shared space to customize the shared space based on the user profile.

11. The method of claim 10, further comprising:
in response to determining that the user profile does exceed the primary user profile, determining whether the user is a member of a user exception group; and
in response to determining that the user is a member of the user exception group, instructing the control unit of the shared space to apply the user profile to the shared space to customize the shared space based on the user profile.

12. The method of claim 11, wherein instructing the control unit of the shared space to apply the user profile to the shared space to customize the shared space based on the user profile comprises instructing, in response to determining that the user is not a member of the user exception group, the control unit of the shared space to apply portions of the user profile that do not exceed the primary user profile to the shared space to customize the shared space.

13. The method of claim 8, wherein the customization service system comprises a profile aggregator that generates the user profile based on user data received from a plurality of data sources.

14. The method of claim 8, wherein the primary user is associated with a primary user profile, and wherein the method further comprises:
determining whether the user remains associated with the shared space; and
in response to determining that the user does not remain associated with the shared space, instructing the control unit of the shared space to apply the primary user profile to the shared space to customize the shared space based on the primary user profile.

15. A computer storage medium having computer-executable instructions comprising a customization client stored thereon that, when executed by a processor of a shared space, cause the processor to perform operations comprising:
obtaining identification information corresponding to a user associated with the shared space;
determining, based at least in part on the identification information, if the user is a primary user of the shared space;
in response to determining that the user is not the primary user of the shared space, receiving a user profile associated with the user from a customization service system; and
instructing a control unit of the shared space to apply the user profile to the shared space to customize the shared space based on the user profile, wherein applying the user profile to the shared space comprises adjusting at least one component of the shared space based on the user profile.

16. The computer storage medium of claim 15, wherein the operations further comprise in response to determining that the user is the primary user of the shared space, providing a primary user profile associated with the primary user to the control unit of the shared space to customize the shared space based on the primary user profile.

17. The computer storage medium of claim 15, wherein the primary user is associated with a primary user profile, and wherein the operations further comprise:
comparing the user profile to the primary user profile to determine if the user profile exceeds the primary user profile; and
in response to determining that the user profile does not exceed the primary user profile, instructing the control unit of the shared space to apply the user profile to the shared space to customize the shared space based on the user profile.

18. The computer storage medium of claim 17, wherein the operations further comprise:
in response to determining that the user profile does exceed the primary user profile, determining whether the user is a member of a user exception group; and
in response to determining that the user is a member of the user exception group, instructing the control unit of the shared space to apply the user profile to the shared space to customize the shared space based on the user profile.

19. The computer storage medium of claim 18, wherein instructing the control unit of the shared space to apply the user profile to the shared space to customize the shared space based on the user profile comprises instructing, in response to determining that the user is not a member of the user exception group, the control unit of the shared space to apply portions of the user profile that do not exceed the primary user profile to the shared space to customize the shared space.

20. The computer storage medium of claim 15, wherein the primary user is associated with a primary user profile, and wherein the operations further comprise:
determining whether the user remains associated with the shared space; and
in response to determining that the user does not remain associated with the shared space, instructing the control unit of the shared space to apply the primary user profile to the shared space to customize the shared space based on the primary user profile.
